(19) United States
(12) Patent Application Publication
(10) Pub. No.: US 2016/0199158 A1
(43) Pub. Date: Jul. 14, 2016

(54) METHOD FOR MAKING SHAPED PRODUCTS

(71) Applicant: MÜHLBAUER TECHNOLOGY GMBH, Hamburg (DE)

(72) Inventor: Rudolf Heymann, Hamburg (DE)

(21) Appl. No.: 14/912,142

(22) PCT Filed: Jul. 11, 2014
(86) PCT No.: PCT/EP2014/064963

§ 371 Date: Feb. 15, 2016

(30) Foreign Application Priority Data
Aug. 23, 2013 (DE) 10 2013 216 855.1

(51) Int. Cl. A61C 13/00; A61C 13/09; B29C 67/00; B29C 39/12; B29C 39/22

(52) U.S. Cl. CPC A61C 13/0016; B29C 39/123; B29C 39/22; B29C 67/0055; A61C 13/0019; A61C 13/09; B29L 2031/7536

(57) ABSTRACT

The invention relates to a method for producing a shaped product which consists of a pseudoplastic material, using a dispensing device for the pseudoplastic material. The method comprises the following steps: •a) applying a layer of material to a carrier body and/or an already applied layer of material by guiding the dispensing device over said carrier body; •b) supplying said applied layer of material with ultrasound, •c) if necessary, repeating the steps a) and b) to produce the desired shaped product, and •d) curing the applied material.

The invention relates to a method for producing a shaped product from a pseudoplastic material, using a dispensing device for the pseudoplastic material.

Dental restorations are mainly produced by classical impression and casting methods. A method is likewise known in which the intra-oral situation to be restored is scanned with the aid of a computer and, on the basis of the data obtained, a dental restoration is produced with the aid of a computer (CAD/CAM method).

CAD/CAM methods for producing permanent tooth replacements are known in particular for ceramic materials. The main area of use is the production of fully ceramic tooth replacements, e.g. by methods involving removal of material, such as milling a tooth replacement part from a ceramic blank. A disadvantage of this is the complex production of the blanks, the strong wear of the milling cutters during the grinding of ceramic blanks, or the limited possibilities as regards coloration and surface properties. This also applies in particular to non-ceramic blanks, for example made from cured dental plastics composites.

CAD/CAM systems are basically composed of 4 components: a scanner, which scans an existing state and digitizes the data, wherein the scanning takes place directly in the mouth (intra-orally) or on a prepared model of the existing situation; a CAD unit consisting of computer and software; a CAM unit with computer-controlled machines that either remove material, e.g. by means of milling cutters, or apply material, e.g. in dots, strings and layers through a nozzle; and a suitable material.

Additive or generative production methods are known in which temporary crowns, for example, are successively built up by 3D printing (EP 1 240 878 B1 and EP 1 243 231 B1).

A particular demand concerns the so-called chairside concept, in which the scanning, the processing of the data by means of software, and the subsequent automated production of the tooth replacement take place exclusively within the dental practice, such that the patient can be treated directly in one session. However, since in particular non-ceramic permanent dental restorations are still also produced in dental laboratories, there is also a great demand for automated production of temporary restorations, in particular temporary crowns or bridges.

It has hitherto not been possible to produce, for example, dental plastics composites of the prior art, e.g. for temporary restorations by means of generative CAD/CAM methods at an acceptable speed and/or in the required or even desired quality.

Examples of dental plastics composites of the prior art are mentioned in WO 2005/084611 and WO 2011/083020.

The object of the invention is to make available a method of the type mentioned at the outset, by means of which many viscous and/or highly viscous materials used, for example, in dentistry can be worked in order to provide shaped products that meet a large number of requirements, in particular as regards flexibility and resistance to fracture.

This object is achieved by a method mentioned at the outset and comprising the following features:
a) applying a layer of material to a carrier body and/or to an already applied layer of material by guiding the dispensing device over this carrier body;
b) exposing this applied layer of material to ultrasound;
c) if necessary, repeating steps a) and b) to produce the desired shaped product, and
d) curing the applied material.

Some of the terms used in the context of the invention will first be explained. The method according to the invention serves for the production of shaped products. These are three-dimensional, hard or (dimensionally stable) curable solid bodies which have a predefined shape (generally calculated with the aid of electronic data processing).

The shaped products are produced from a pseudoplastic material. Pseudoplastic means that the material as a fluid exhibits decreasing viscosity as shear forces increase. Pseudoplasticity always exists in dispersions, for example dental composites, which are generally dispersions of finely particulate inorganic filler in a polymerizable monomer or oligomer mixture, also called a resin matrix.

According to the invention, the carrier body used can be a plane surface (plate) or the like, although it is preferable to use a carrier body that exerts a supporting function or has the inner contour of a shaped product to be built up. For example, if a crown is to be produced, the carrier body preferably used is an exact model or replica of the tooth stump that is to be crowned. For example, if a veneer is to be produced, the carrier body preferably used is the actual shaped product to be veneered, for example a metal crown. The dispensing device or nozzle and the carrier body are preferably arranged movably relative to each other by means of a 5-axis application device, such that the nozzle can execute any movement relative to the carrier body and can follow complicated contours.

According to the invention, a layer of material can preferably be applied in strings or in droplets. The invention thus permits an additive buildup of shaped products (3D printing) from pasty, pseudoplastic materials which could not hitherto be used, at least not without considerable limitations, for 3D printing. According to the invention, the 3D printing for the production of a shaped product can be effected by deposition of strings (analogous to fused deposition modeling (FDM)) or application of droplets (e.g. multi-jet modeling (MJM)).

The layer thickness during the application is defined by the distance between the nozzle tip and the surface onto which material is applied. A further factor determining the layer thickness particularly when applying a string is the string thickness, which is in turn closely determined by the diameter of the nozzle opening.

An applied layer, or an applied string/droplet of material, preferably has a thickness that is less than the depth of penetration of the ultrasound.

The curing as per step d) can take place in a manner familiar to a person skilled in the art, preference being given to the use of light-curing materials and, accordingly, a polymerization by the action of light in the absorption spectrum of photoinitiators contained in the material. In the course of production of a shaped product, the curing can be carried out a number of times, for example after each application of a certain amount of material, for example of each layer of material, each string of material or the like. However, as will be explained in more detail below, it is a particular advantage of the method according to the invention that the shaped product produced does not necessarily have to be cured layer by layer, and instead the curing of a plurality of layers, particularly preferably of all the layers, of the shaped product can take place in one go.

A key aspect of the method according to the invention is that already applied material is exposed to ultrasound.

The invention has recognized that, upon successive application of droplets or strings of pseudoplastic materials, a problem can arise whereby they do not flow into each other sufficiently at the contact surfaces, as a result of which weak points can occur there after the curing. The exposure to ultrasound as provided according to the invention ensures that a last applied layer of material (for example a string or droplet) flows together better with the layer of material below it and/or with adjacently applied droplets or strings, thereby providing a more intimate connection and, after the curing procedure, forming a stronger composite.

The method according to the invention permits the buildup of the shaped product from individual droplets, strings or layers using a pseudoplastic material which, during the shaping process (without the action of ultrasound), is substantially stable, that is to say does not flow or deform to any great extent, if at all, even prior to the curing procedure, i.e. at least one layer of material is dimensionally stable (dimensional change <5 μm) at least during the time of the shaping process at ambient conditions (23° C., normal pressure). When using such a material with a high degree of stability, a problem can arise whereby individual droplets, strings or layers do not connect sufficiently to one another. This problem is solved by the exposure to ultrasound as provided according to the invention. The method according to the invention makes it possible to use relatively stable pseudoplastic materials, which means that a shaped product that is formed does not have to be cured layer by layer (in order to avoid running), and instead a plurality of layers, strings or droplets, preferably all of the layers of the finished shaped product, can be cured in one go. The invention likewise means that the buildup of layers does not have to be plane since, according to the invention, layers of material applied to inclined surfaces also have sufficient dimensional stability and do not run off.

According to a further aspect of the method according to the invention, the exposure to ultrasound can also be used to smooth or remodel layers of material that have already been applied but have not yet been cured.

According to one variant of the invention, the applied layer of material can be exposed to ultrasound using an ultrasound device mounted on the dispensing device. The application of a new layer of material then takes place synchronously with the ultrasound exposure. In this variant of the method according to the invention, it is possible, for example, to use a nozzle, described below in connection with the illustrative embodiment, with an ultrasound device which can be controlled as a switch for switching the flow of material on and off. This ultrasound device can then have a dual function and at the same time expose the applied layer of material to ultrasound. In the context of the invention, it is likewise possible to provide the dispensing device with an ultrasound device which exclusively has the function of exposing an already applied layer of material to ultrasound.

According to an alternative variant of the invention, provision can be made that the applied layer of material is exposed to ultrasound using an ultrasound device separate from the dispensing device. This variant can be advantageous particularly when, for example, an already applied layer of material subsequently has to be smoothed or remodeled. It is then possible, for example, to use a separate ultrasound tip.

According to the invention, the feed rate of the dispensing device or nozzle during the application can be between 5 and 10 mm/s, for example. If an ultrasound device separate from the nozzle is used, the feed rate thereof can optionally be higher.

The invention allows existing additive or generative CAD/CAM systems to be modified such that the working of highly viscous plastics composites is improved. Chairside production of tooth replacements with good flexural strength, radiopacity, pressure resistance, dimensional stability, surface smoothness, abrasion resistance and coloration is made possible.

The ultrasound frequency preferably lies in the range from 20 kHz to 1 GHz, further preferred ranges being from 20 kHz to 1 MHz, particularly preferably 20-100 kHz or 20-60 kHz. Preferably, the frequency is not varied and is instead a fixed value.

Particularly in the case of dental material, suitable filler contents are between 40 and 85 percent by weight, more preferably between 50 and 85 percent by weight, particularly preferably between 60 and 85 percent by weight. Particle sizes of less than 50 μm, more preferably less than 25 μm, are preferred. In the case of so-called microfillers, mean particle sizes of 0.5-20 μm are preferred. The microfillers preferably used are the dental glasses familiar to a person skilled in the art. When using nanofillers, their primary particle size is preferably between 1 and 500 nm, more preferably between 1 and 300 nm. Preference is given here to the use of silicon dioxide or mixed oxides of silicon dioxide.

The pseudoplastic materials, particularly for use in dentistry, have a polymerizable matrix of monomers, oligomers, prepolymers and/or polymers and also suitable additives and additions familiar to a person skilled in the art. Particularly preferably, the polymerizable matrix contains 60-90 percent by mass of Bis-GMA and/or UDMA.

For example, dental materials for use in dental restorations preferably require a flexural strength of at least 80, preferably at least 100, more preferably at least 120 MPa (ISO4049:2009(E)). The pressure resistance is preferably at least 220, more preferably at least 250, more preferably at least 290 MPa. The stated values relate to the dental material after curing thereof.

A device for producing shaped products from a pseudoplastic material, which device can be used in the context of the method according to the invention, is described below.

This dispensing device has at least one sonotrode and/or a nozzle which is designed to dispense the material.

The outlet channel of a nozzle preferably has a free cross section tapering toward the nozzle outlet. This means that the free cross-sectional area of the channel transverse to the main direction of flow is smaller in the area of the nozzle outlet than in the area lying upstream.

An ultrasound device is arranged in the flow path of the material in a nozzle, before or in the area of the nozzle outlet. The ultrasound device is designed to apply ultrasound to an edge area of the material flowing through the outlet channel.

The ultrasound device is arranged in such a way and/or controlled or regulated in such a way that the material reservoir is not exposed to ultrasound or at any rate not at the same time as the outlet channel of the dispensing device.

The dispensing device preferably has no mechanical valve. This means that, at least in the area before the nozzle outlet, the flow of material cannot be interrupted by mechanical elements, valves or the like.

It is possible that a mechanical valve, or some other mechanical blocking device for the flow of material, is provided far upstream from the nozzle outlet, for example in the area of a delivery device (for example a pump) for the material.

A control device is provided by means of which the ultrasound device can be controlled as a switch for switching the flow of material on and off in a nozzle.

Highly viscous dispersions can usually only be dispensed very slowly, if indeed at all, through fine nozzles having a free cross section that tapers toward the nozzle outlet.

The pseudoplastic properties of a material to be dispensed can be utilized in order to control the flow of material in the area of the nozzle outlet by application of ultrasound, without any mechanical device which closes the nozzle opening or the outlet channel in the area of the nozzle opening or reduces the free cross-sectional area thereof for interrupting the flow of material. The control the flow of material, the pseudoplastic properties are utilized by applying ultrasound. If the ultrasound device is switched off, the delivery pressure of the delivery device is not sufficient to allow the pseudoplastic material to emerge through the tapering cross-sectional area before the nozzle opening or through the nozzle opening.

By applying ultrasound to the edge area of the outlet channel in the area of the nozzle opening, the viscosity of the pseudoplastic material located in this area decreases to such an extent that the delivery pressure is sufficient to allow the emergence from the nozzle opening. The ultrasound device thus has the function of a switch that can start and stop the flow of material without mechanical elements and without a change of the free cross section.

Dental materials for permanent dental restorations (for example crowns and bridges, inlays or onlays) are often ceramic materials or resin-based composites that contain a high proportion of filler. In the prior art, such highly filled pasty substances can be dispensed in a controlled manner through a nozzle only if the flow of material is controlled by a mechanical valve. However, valves have a tendency to become clogged by the solid fillers of the material. The alternative, likewise known in the prior art, of starting and stopping the flow of material by switching the delivery pump on and off has the considerable disadvantage that the very slow reaction and a continued flow of the delivered material make precisely defined dispensing of the material from a nozzle difficult or impossible.

The described device preferably omits such a valve and has, in the outlet channel, a conical taper extending toward the nozzle opening, which initially appears absurd since this increases the difficulty of dispensing the material. However, this conical taper is used in combination with the ultrasound device as valve without mechanical elements.

The device utilizes the property of a pseudoplastic material to reduce the viscosity under the influence of shear. Applying ultrasound to an edge area means that a sufficiently thick layer in the edge zone of the nozzle channel (layer thickness of 10 μm for example) has its viscosity reduced to such an extent that the pump pressure or delivery pressure is sufficient to allow all of the material to pass through the nozzle channel and emerge from the nozzle. The amplitude of the ultrasound is preferably chosen such that the depth of penetration of the ultrasound into the material located in the nozzle channel is of such an order that preferably only this edge zone is influenced and has its viscosity reduced. According to the invention, it is possible, for a short period of for example 0.2 to 1 second at the start of each dispensing procedure, for the amplitude of the ultrasound to be chosen higher than would be necessary for emergence from the nozzle, in order to more quickly overcome the initial thixotropy of the material or more quickly achieve the flow limit of the material. The device purposefully exploits the pseudoplastic behavior of the material in order to control the flow of material.

According to the invention, the ultrasound device serves as a discrete on/off switch, by means of which the flow of material can be switched on and off. The ultrasound device is therefore not only a means for increasing, or permitting in the first place, the flow through a nozzle; instead, according to the invention, it is purposefully assigned the function of a valve.

This therefore makes available a device with which shaped products can be produced, for example in dentistry, in the production of printed circuit boards, the production of electromagnetic shields or the like. A common feature of all these applications is that, in order to produce appropriate shaped products, use is made of pasty materials which have a high degree of filling (high proportion of solids dispersed therein) and which can be dispensed only with difficulty, if indeed at all, through nozzles of the prior art. It has been shown that highly filled pasty substances (highly viscous dispersions) can be dispensed without undesired phase separation. Phase separation occurs if, on account of the different flow behavior of the constituents of a dispersion, the liquid constituents flow more easily or more quickly and, consequently, a separation from the solids occurs.

The delivery device can be designed to maintain a substantially constant delivery pressure, irrespective of whether the flow of material is switched on or off. It is then preferable if the delivery pressure is adjusted or regulated such that it is below the outlet pressure of the pseudoplastic material when the ultrasound device is switched off and exceeds this pressure when the ultrasound device is switched on. A delivery pressure is thus chosen which, in the rest state (without ultrasound), is not sufficient to drive the pseudoplastic material through the nozzle channel and in particular not sufficient to drive it through the conically tapering outlet opening. By switching the ultrasound on and applying the ultrasound to the edge area of the material, the flow behavior of the latter is changed such that the delivery pressure obtained is sufficient to allow material to flow through the nozzle opening. For example, if a cylindrical cartridge containing pseudoplastic material is connected by a line, with an internal diameter of 2 mm, to a nozzle whose outlet openings have a diameter of 100 μm, the delivery pressure in the interior of the cartridge can be 3-5 bar. By pressure losses, it is then possible to establish a delivery pressure in the range of 2-3 bar at the entrance of the nozzle (end of the line with an internal diameter of 2 mm).

The free cross-sectional area of the outlet channel is greater than the free cross-sectional area of the nozzle outlet opening. Preferred ratios of size lie in the range of 1:2 to 1:1000, more preferably 1:5 to 1:500, particularly preferably 1:10 to 1:50. The free cross-sectional area of the nozzle outlet opening can preferably be between 3000 and 300000 μm², more preferably 3000 to 100000 μm², more preferably 3000 to 30000 μm², more preferably 3000 to 10000 μm².

In the case of a circular cross section of the opening of the nozzle, this corresponds to an opening diameter in the range of 60-600 μm, wherein diameters of below 200 μm are preferred. Particularly preferred nozzle diameters are between 60 and 100 μm.

The device can contain further material reservoirs and further nozzles (and dispensing units, etc.) with larger nozzle diameters than those preferred according to the invention. For rapid buildup of internal layers or base shapes, it is possible, for example, to work with larger nozzle diameters. For the exact creation of shaped products or shaped product parts in the range below 200 μm, or of outer contours of base shapes, a smaller nozzle diameter can accordingly be chosen. For the buildup of carrier bodies, it is preferable to choose a less exacting material or a larger nozzle diameter.

The ultrasound device can be designed to apply ultrasound to an edge area, with a thickness of 5 to 30 μm, preferably 5 to 15 μm, of material located in the outlet channel. Ultrasonic oscillations are strongly damped in pseudoplastic pastes, in particular with a high filler content.

The oscillation amplitude thus quickly decreases as the depth of penetration into the material increases. Therefore, the depth of penetration can be influenced in particular by adjusting the amplitude. To achieve a depth of penetration in the stated ranges, the amplitude of the ultrasound can lie in the range of 2-6 μm during a work procedure or flow. After the ultrasound has been switched on, it may be preferable, for a short period of preferably 0.2-1 second, to slightly increase the amplitude, for example to values of 9-12 μm. This initially increased amplitude serves to ensure that an initial delay in the discharge of the material, caused by a certain inertia, is kept as low as possible, since the high energy input very quickly reduces the viscosity. Thus, the viscosity can very quickly be reduced to about half or less.

It is preferable that the outlet channel for the material tapers conically toward the nozzle outlet.

The cone angle can preferably be 10 to 170°, preferably to 170°, more preferably 95 to 160°, more 20 preferably 100 to 140°. A cone angle of 120° is particularly preferred. In the preferred size ranges, the cone angle is therefore much greater than in customary, conically tapering nozzle tips in the prior art. There, the cone angle is usually 45°. The preferably large cone angle generates a high dynamic pressure, which in particular contributes to rapid blocking of the flow of material after the ultrasound is switched off. Moreover, the cone contributes to the desired action of the ultrasound, particularly in the edge areas, since the penetration of the ultrasound, in the case of the preferably used sonotrode described in more detail below, takes place mainly in the longitudinal direction of the nozzle, and the ultrasound acts on the material mainly in the area of the conical taper.

A further aspect is the combination of a described device with a pseudoplastic material that can be dispensed by means of this device. In the context of this combination, the reservoir for the material is filled with such a pseudoplastic material.

The material preferably has a solid filler, which is dispersed in a liquid matrix. Particularly in the medical field, this is understood as a dispersion. For such composites, a certain solid content is necessary in order to be able to produce usable prosthetic materials with properties allowing them to be used in the medical field.

Illustrative embodiments of the invention are described below with reference to the drawings, in which:

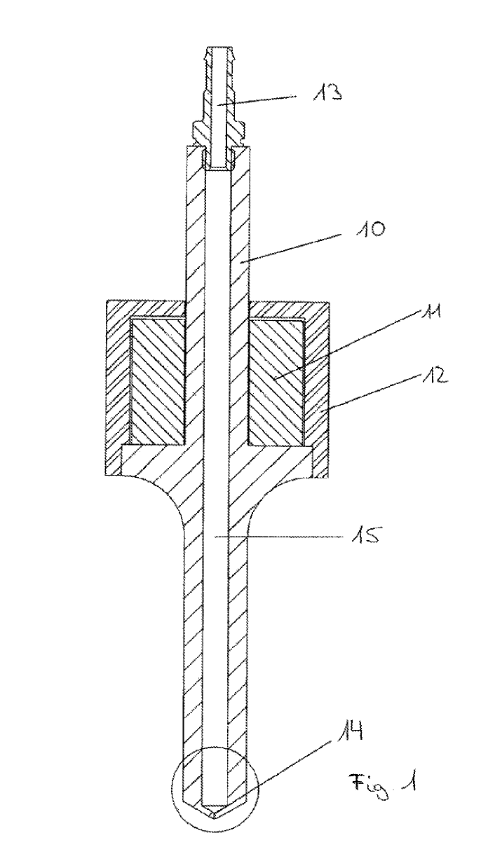

FIG. 1 shows a schematic representation of an ultrasound device and nozzle of a device that can be used according to the invention;

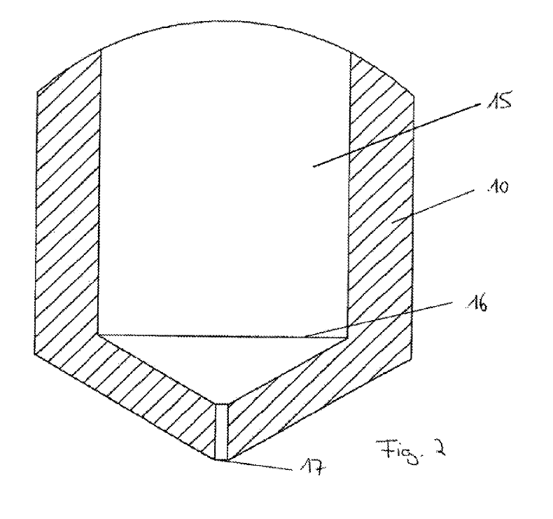

FIG. 2 shows a detail illustrating the nozzle tip.

The dispensing device 10 according to the invention in FIG. 1 has at 13a an inlet for pseudoplastic material from a material reservoir 13. This material can flow through an outlet channel 15 to a conically tapering nozzle tip 14. It will be seen from the detail in FIG. 2 that the channel 15, starting at 16, tapers conically toward the nozzle tip 17 which, in this illustrative embodiment, has an opening diameter of 100 μm.

The ultrasound device can be seen at 12 and has a piezo actuator 11. By applying an alternating current to the piezo actuator 11, the material located in the channel 15, and in particular in the area of the nozzle tip 14, can be exposed to ultrasound. In this illustrative embodiment, the ultrasound frequency is 60 kHz and the amplitude of the ultrasound is 6 μm (longitudinally in the direction of flow of the material). The delivery pressure acting on the material located in the channel is set such that, although the material can flow through this channel 15, the conical taper toward the nozzle tip 17 prevents the material from flowing out of the nozzle tip 17 as long as the ultrasound is not switched on. When ultrasound is applied, the viscosity decreases in the area of the conical taper 16, particularly in the edge area of the material, to such an extent that the material can pass through the nozzle tip 17.

1. A method for producing a shaped product from a pseudoplastic material, using a dispensing device for the pseudoplastic material, characterized by the following steps:
a) applying a layer of material to a carrier body and/or to an already applied layer of material by guiding the dispensing device over this carrier body;
b) exposing this applied layer of material to ultrasound;
c) if necessary, repeating steps a) and b) to produce the desired shaped product, and
d) curing the applied material.

2. The method as claimed in claim 1, characterized in that the applied layer of material is exposed to ultrasound using an ultrasound device mounted on the dispensing device.

3. The method as claimed in claim 1, characterized in that the applied layer of material is exposed to ultrasound using an ultrasound device separate from the dispensing device.

4. The method as claimed in one of claims 1 through 3, characterized in that the feed rate of the dispensing device during the application is between 5 and 10 mm/s.

5. The method as claimed in one of claims 1 through 4, characterized in that ultrasound is applied at a frequency of 20 kHz to 1 GHz, preferably 20 kHz to 1000 kHz, more preferably 20 to 100 kHz.

6. The method as claimed in one of claims 1 through 5, characterized in that ultrasound is applied at an amplitude of 1 to 20 μm, preferably 5 to 15 μm, more preferably 9 to 12 μm or 2 to 6 μm.

7. The method as claimed in one of claims 1 through 6, characterized in that the pseudoplastic material has a filler content of 40 to 85 percent by weight.

8. The method as claimed in one of claims 1 through 7, characterized in that the pseudoplastic material has fillers with a particle size of 50 μm or less.
